(19) United States
(12) Patent Application Publication
(10) Pub. No.: US 2013/0305853 A1
(43) Pub. Date: Nov. 21, 2013

(54) THREE-SHAFT ADJUSTMENT MECHANISM WITH ALTERED MASS DISTRIBUTION AND METHOD FOR PRODUCING A SHAFT GENERATOR

(71) Applicants: Jens Schaefer, Herzogenaurach (DE); Mike Kohrs, Oberreichenbach (DE); Jeffrey S. Balko, Herzogenaurach (DE)

(72) Inventors: Jens Schaefer, Herzogenaurach (DE); Mike Kohrs, Oberreichenbach (DE); Jeffrey S. Balko, Herzogenaurach (DE)

(73) Assignee: SCHAEFFLER TECHNOLOGIES AG & CO. KG, Herzogenaurach (DE)

(21) Appl. No.: 13/981,331

(22) PCT Filed: Dec. 1, 2011
(86) PCT No.: PCT/EP11/71532

§ 371 Date: Jul. 24, 2013

(30) Foreign Application Priority Data
Feb. 14, 2011 (DE) 10 2011 004 066.8

(51) Int. Cl. F16H 19/00

(52) U.S. Cl. CPC F16H 19/001
USPC 74/63; 264/279; 164/108; 164/55.1

(57) ABSTRACT

A three shaft adjustment mechanism including a drive part which can be connected to a drive shaft in a rotationally fixed manner, a driven part which can be connected to a driven shaft, and an actuator which can be connected to an adjustment shaft as a mechanism part. A mechanical stop for defining an adjustment angle between the drive shaft and driven shaft is provided between two of the three shafts. According to the invention, the mechanism part not involved in the stop has a mass distribution or form which is such that a quotient from its mass moment of inertia J and its partial radius r is smaller than 0.4 kg×mm. The invention also relates to a method for producing a shaft generator having this type of mechanism.

### BACKGROUND

The invention relates to a triple-shaft adjustment mechanism. The invention also relates to a method for producing a shaft generator of such a triple-shaft adjustment mechanism.

Triple-shaft adjustment mechanism are used, for example, in internal combustion engines for adjusting the phase angles, primarily for adjusting the opening and closing times of the gas-exchange valves (camshaft adjuster, phase adjuster for actuator shafts for variable valve drives). The phase adjuster is here arranged as an actuator in a triple-shaft system. Primarily, the drive power that is discharged again via the driven shaft (e.g., camshaft) is fed to the triple-shaft system via the drive shaft (timing chain sprocket). The actuator is here arranged in the flow of power as a connecting element between the drive shaft and the shaft to be driven. It allows additional mechanical power to be coupled into the shaft system or to be discharged from this system via a third shaft (adjustment shaft) superimposed on the drive power. Therefore, the movement function (phase angle) specified by the drive shaft and relative to the driven shaft can be changed.

Examples for such triple-shaft adjustment mechanisms are wobble-plate mechanisms and internal eccentric mechanisms that are described, for example, in WO 2006/018080. Included here are also the shaft mechanism known from WO 2005/080757 and the mechanisms contained in US 2007/0051332 A1 and US 2003/0226534 A1.

Different phase adjusters are known from the prior art. For example, electromechanical camshaft adjusters are described in DE 10 2004 009 128 A1, DE 10 2005 059884 A1, and DE 10 2004 038 681 A1.

One special case of a triple-shaft adjustment mechanism is a double-shaft arrangement in adjustment drives in which the drive shaft is mounted on the housing, i.e., power is transmitted only between the adjustment shaft and driven shaft. Such a device is used to convert a drive power of an actuator fed with high speed and low load into a driven power with low speed and high load and is used, for example, in speed-reduction devices for actuator drives in the automotive field and also in industrial applications, e.g., in robots.

From DE 10 2008 045 013 A1, a shaft mechanism is known in which, for simplified assembly and for improving the mechanical properties, the intermediate gear ring (flexspline) and the housing or at least one housing part are manufactured as an integral plastic molded part.

To protect parts in the surroundings of such adjustment mechanisms from undesired collisions of parts in the event of control errors by the actuating system, the adjustment range or the drive range is limited by defining the rotational angle of one of the three shafts relative to a second shaft or relative to the housing. For this purpose, a mechanical stop is used as an integral part of the device. In the known prior art of the camshaft adjuster, the stop is provided between the driven shaft and the drive shaft, because the adjustment shaft usually covers an angle of more than 360°.

In such a design, the adjustment shaft not directly limited in the adjustment angle or drive angle is then braked in the case there is contact with the stop by means of the mechanism kinematics and the stiffness of the mechanism elements, as soon as the driven side reaches the limits of the rotational angle. Here, due to the extremely high loads, mechanism parts can be so strongly deformed that they collide with each other and cause the actuator to jam. Furthermore, mechanism parts can wear out prematurely or must be over-dimensioned for normal operation, in order to also survive the high loads in the case of unbraked contact with the stop.

### SUMMARY

The object of the invention is to construct a triple-shaft adjustment mechanism such that the effects of pulse loads that occur when there is contact with the stop in the actuator are damped.

The objective is met by a triple-shaft adjustment mechanism according to the invention and by a method for producing a shaft generator of a triple-shaft adjustment mechanism.

A triple-shaft adjustment mechanism according to the invention comprises a drive part that can be connected to a drive shaft in a rotationally fixed manner, a driven part that can be connected to a driven shaft, and an actuator that can be connected to an adjustment shaft as parts of the mechanism. Between two of the three shafts there is a mechanical stop for defining an adjustment angle between the drive shaft and the driven shaft.

According to the invention, the mechanism part running indirectly onto the stop has a mass distribution or shape resulting in a quotient of less than 0.4 kg×mm calculated from its mass moment of inertia J reduced overall to the adjustment shaft and its reference circle radius r of the ratio gear wheel. The reduction to the adjustment shaft takes into account the gear ratio.

The advantages of the invention can be seen especially in that the service life and operational reliability of this mechanism can be significantly improved. The invention avoids the occurrence of incorrect functions in that, e.g., the actuator part can no longer become jammed in the end stop due to the high loads and can no longer become detached from the actuator. In addition, the mechanism can be produced with significantly smaller dimensions and this smaller size is connected to cost and weight advantages.

The mass distribution or shape according to the invention can be advantageously achieved in that at least one of the mechanism parts is made from plastic or lightweight metal.

The invention is described below with reference to an electromechanical camshaft adjuster with a shaft mechanism, but could also be transferred to other mechanism shapes or to double-shaft arrangements of triple-shaft adjustment mechanisms.

The drive part is, in this example, the chain wheel that is connected with a drive connection to the crankshaft of the internal combustion engine by means of a chain drive mechanism. The driven part is connected with a drive connection to the camshaft. The mechanical stop is provided between the chain wheel and the camshaft gear.

If a shaft mechanism is used, the chain wheel and camshaft gear have internal teeth that mesh in external teeth of a shaft generator. The function of a shaft mechanism is known to someone skilled in the art and therefore does not need to be explained in more detail.

When the mechanical stop is reached, the mechanism loses its gear-translation function. In the stop position it still rotates (in its direction) only as a rigid coupling at the speed of the drive gear wheel. The speed of the camshaft is suddenly changed to the speed of the drive shaft. The necessary change in the motion energy of the camshaft is here realized by converting energy via the parts forming the stop (potential energy, deformation energy, friction energy). The motion energy of the still free adjustment shaft must be converted in the same way (conservation of energy). Due to the stop on the driven side, the necessary energy for changing the motion energy must be absorbed by deformation or damping energy in the parts of the mechanism. This results in a high load on the parts of the mechanism.

The movement speed of the adjustment shaft, that is, the rotational speed, is higher than the speed of the driven shaft immediately before contacting the end stop by the factor of the gear-translation ratio i_AB. For the same moments of inertia on both sides, the energy would be greater by i², i.e., the deceleration values on the adjustment shaft side are greater by a multiple. Through the law M=J_{zz}×a (moment=moment of inertia×angular acceleration), even for small mass moments of inertia, on the adjustment shaft side the mechanism is already subject to high loading moments that are to be reduced.

By reducing the mass moment of J in comparison to the mechanisms used in the prior art, a reduction of the loading moment can be achieved. For this purpose, the geometric relationships of the actuator must be considered. These relationships are subject to certain design constraints, such as load and stress, as well as the required translation ratio.

According to the invention, a quotient of less than 0.25 kg×mm is achieved, calculated from the mass moment of inertia of the adjustment shaft as part of the actuator and a reference circle radius of the gear-ratio wheel (external teeth of the spline gear for shaft mechanisms).

A quotient calculated from the mass moment of inertia of the adjustment shaft and the dynamic drive moment that can always be transmitted is less than 0.55×10⁻³ s².

Because the mass moment of inertia of the motor shaft and the rotating parts of the electric motor must also be considered, for the overall consideration of the electric motor and adjustment shaft, the quotient calculated from the mass moment of inertia of the actuator and a reference circle radius of the gear-ratio wheel produces values less than 0.4 kg×mm and the quotient calculated from the mass moment of inertia of the actuator and the dynamic drive moment that can always be transmitted produces values less than 0.8×10⁻³ s².

In one preferred embodiment of the invention in which the mechanism is a shaft mechanism, the actuator or parts of the actuator are produced as a shaft generator made from plastic or lightweight metal. Here, an adjustment shaft of the actuator is preferably formed as a hollow shaft that has either at least two axial receptacle holes or an axial receptacle peg or other receptacles, such as recesses, slots, or the like for a coupling element for coupling the shaft of the electric motor.

The adjustment shaft can also be formed integrated with the running surface of the inner ring of the roller bearing of the shaft generator. In this case, a reduced, profiled cross section is selected, in order to not influence the radial stiffness of the adjustment shaft.

For a double-row ball bearing of the shaft generator, the ball rows are not arranged axially one next to the other, but are instead offset relative to each other, so that the reduced width achieves savings in materials on the large radius on the inner ring, which reduces the mass moment of inertia.

A method according to the invention is used for producing an actuator as a mechanism part, wherein the double-shaft adjustment mechanism is formed as a shaft mechanism and the actuator is produced as a shaft generator made from plastic or lightweight metal.

For this purpose, a flexible, thin-walled inner ring is inserted into or drawn onto a first molded body. Here, the inner ring is made into an oval shape through the application of a radial compressive or tensile force. That is, the first molded body has either oval inner contours or outer contours, at least in some sections. Then a second molded body is placed on or inserted into the first molded body, wherein a mold for filling up with a liquid material is formed in the inner area of the inner ring. This mold is advantageously an injection-molding or casting mold. The hollow space between the molded bodies and the inner ring is now filled or sprayed with liquid plastic or aluminum and then the inner ring is removed.

In one preferred embodiment of the method, before filling up the hollow space, ribs are placed in the molded bodies. In another embodiment, reinforcing fibers or the like can be added to the liquid plastic or lightweight metal. In another modified embodiment, in addition to the inner ring, additional parts can be molded, for example, a gear wheel or magnetic wheel as a position sensor, so that a magnetic or mechanical coding of the adjustment shaft of the triple-shaft adjustment mechanism is realized that can be used in a known way for determining the relative or absolute position.

### BRIEF DESCRIPTION OF THE DRAWINGS

Preferred embodiments of the invention are explained in more detail below with reference to the figures. Shown are:

FIG. 1: a shaft generator with an adjustment shaft that has a cross-sectional profile and is formed integrally with an inner ring, in three-dimensional and cross-sectional representations;

FIG. 2: a second embodiment of the shaft generator that has a cross-sectional profile and is formed integrally with an inner ring, in three-dimensional and cross-sectional representations;

FIG. 3: a third embodiment of the shaft generator with a double-row ball bearing in a cross-sectional representation;

FIG. 4: different embodiments of the shaft generator made completely or partially from plastic each in a cross-sectional representation;

FIG. 5: a representation of a method sequence according to the invention for producing a base body of a shaft mechanism;

FIG. 6: an alternative molded body for use in the method according to the invention;

FIG. 7: several cross-sectional shapes of modified embodiments of the inner rings of the shaft generator;

FIG. 8: a detailed drawing of a modified embodiment of a shaft generator with axial recesses;

FIG. 9: a cross-sectional representation of an embodiment of the shaft generator with roller bodies produced as hollow bodies;

FIG. 10: a schematic diagram of an inner ring with integrated angle coding.

### DETAILED DESCRIPTION OF THE PREFERRED EMBODIMENTS

FIG. 1 shows a shaft generator as an actuator of a triple-shaft adjustment mechanism constructed as a shaft mechanism in a three-dimensional representation and in a cross-sectional view. Such a shaft generator is known in principle to someone skilled in the art.

In the illustrated embodiment, an adjustment shaft 01 is formed integrally with an oval-shaped inner ring running surface 02 of a roller bearing. Roller bearings, in this embodiment provided as balls 03, are guided in a cage 04 between the inner ring running surface 02 and an outer ring 06.

The adjustment shaft 01 is formed as a hollow shaft whose cross-sectional shape has a profile that is different from a rectangle. Here, the cross-sectional shape has a wider section in the area of the inner ring running surface 02 and a narrow section projecting inward in the radial direction. On each of two diametrically opposite sides of the inner periphery of the narrow section there is a receptacle hole 08 in projections 07 extending radially inward for fastening a now-shown coupling element. This coupling element is used to couple a shaft of an electric motor to the adjustment shaft 01 with compensation of an axial offset. By profiling the cross-sectional shape, savings of mass and thus a reduction of the mass moment of inertia of the adjustment shaft 01 in comparison with the prior art is achieved independent of the selection of materials.

The outer ring 06 carries not-shown spur gear teeth that mesh, for the structural shape as a flat mechanism, in two ring gears (chain wheel and camshaft wheel) each at two diametrically opposite ends. Obviously, the shaft generator could also be formed for a pot-shaped mechanism.

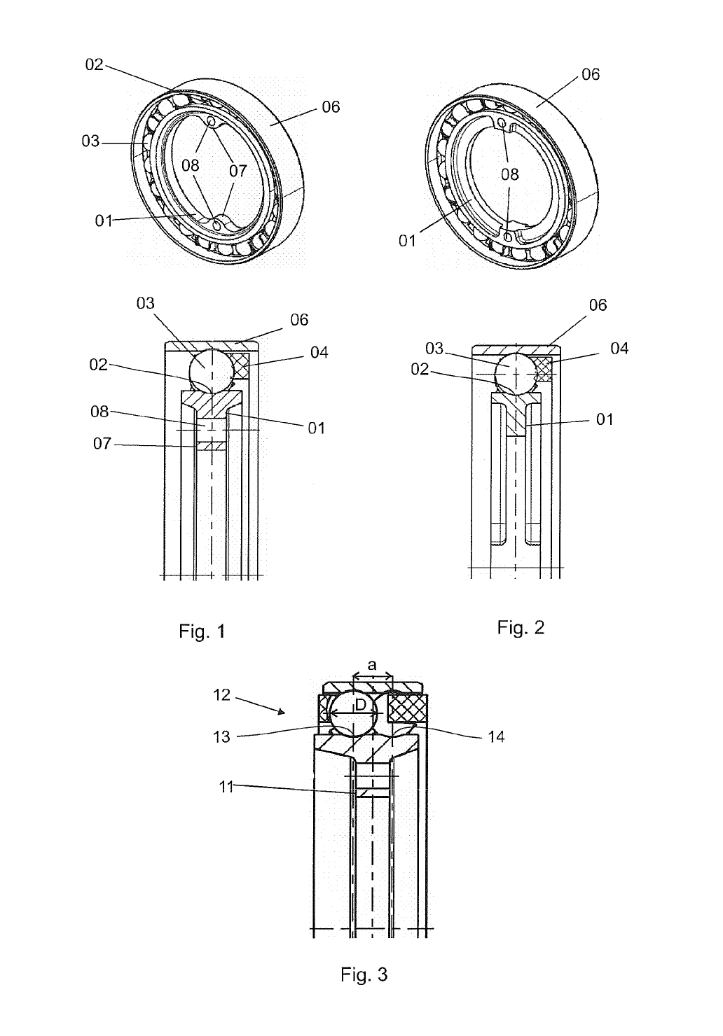

For the embodiment shown in FIG. 2, the cross-sectional profile of the adjustment shaft is selected so that the receptacle holes are not provided in projections, but instead the inner periphery has a circular shape, so that a shaft can be optionally pushed into the adjustment shaft 01.

FIG. 3 shows an adjustment shaft 11 of a shaft generator with a double-row ball bearing 12 in which inner ring running surfaces 13, 14 have a smaller distance a from each other in the axial direction than the diameter D of the balls 03 (or a width of the roller bodies for cylindrical roller or needle bearings). The balls 03 are each arranged in the peripheral direction alternating in the running surfaces 13, 14, that is, offset. Therefore, in comparison to conventional double-row bearings of a shaft generator, axial designed space is saved and thus the mass moment of inertia of the adjustment shaft 01 is reduced in the way according to the invention.

The invention is not limited to the cross-sectional shapes shown here. Someone skilled in the art can easily make modifications. Here, another wider section could also be adjacent, for example, to the narrow section. For the cross-sectional shape, care must be taken that the radial stiffness is not adversely affected.

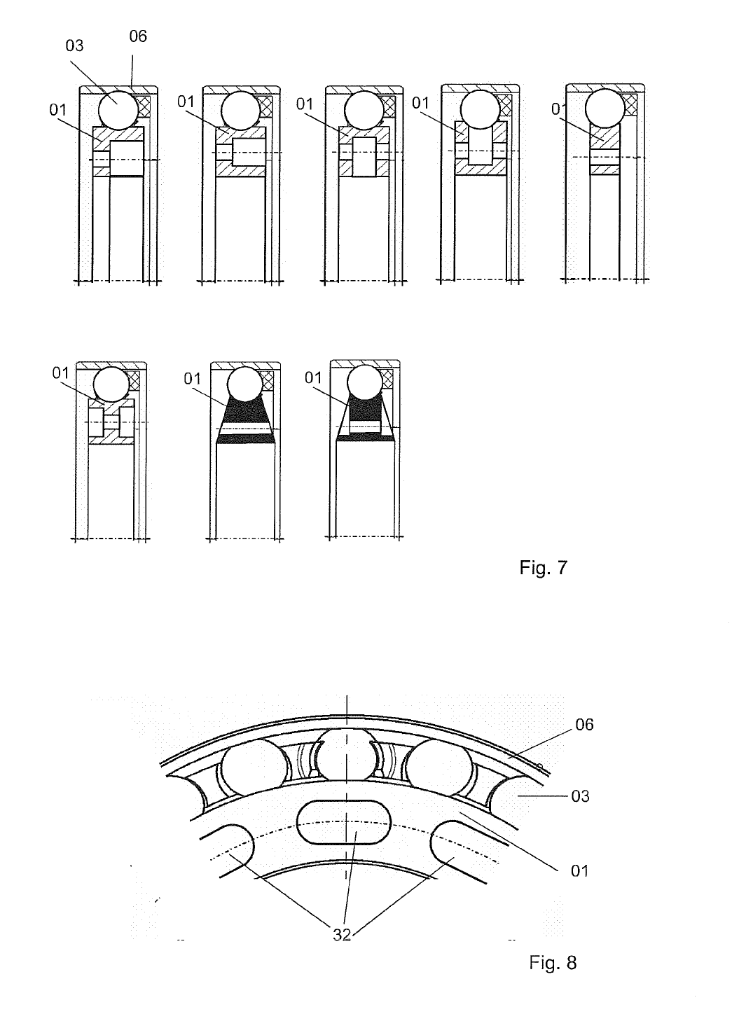

In FIG. 7, other possible cross-sectional shapes are shown as examples, in the shown sequence as an angle profile, U-profile in different positions, I-profile with smaller width than the diameter of the roller body, double-T-profile, as well as trapezoidal profile with or without ribs.

The inner rings of the shaft generator shown in the different cross-sectional shapes can also have equally or unequally distributed axial holes or recesses 32 on the periphery (see FIG. 8) in order to further reduce the mass moment of inertia. The recesses should be oriented at a certain reference to the major axis of the ellipse so that the radial stiffness can be intentionally increased or reduced at that point.

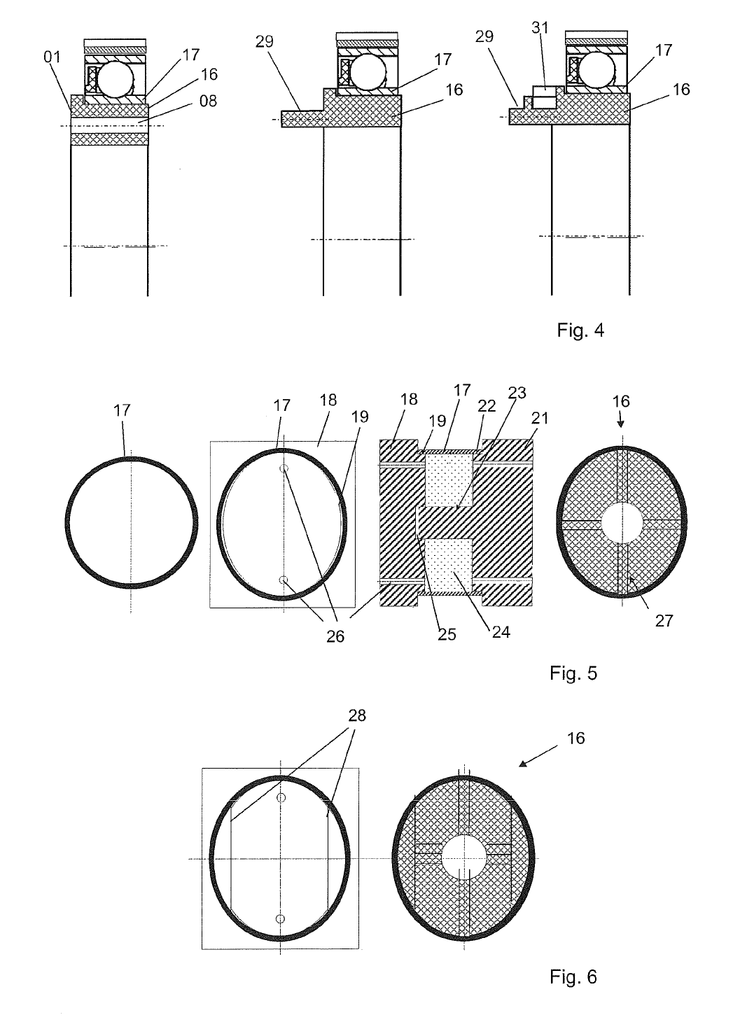

In FIG. 4, three different embodiments of a shaft generator according to the invention are shown in which a base body 16 of the shaft generator that has an oval shape at least in some sections and forms the adjustment shaft 01 is made from plastic or lightweight metal. A thin inner ring 17, roller body 03, cage 04, and outer ring 06 are arranged on the oval base body 16 in a known way.

The adjustment shaft 01 can have the already described axial through-hole 08 for the mounting of a coupling device or a receptacle peg 29 for the coupling element. In the area between the receptacle peg 29 and the inner ring 17 there can also be a molded gear ring or magnetic ring 30 for a position sensor. In the right-hand drawing of FIG. 4, the external teeth 31 of the shaft generator formed on the outer ring 06 can be seen.

FIG. 5 shows the sequence of a method according to the invention for producing the base body 16 of the shaft generator shown in FIG. 4. The base body 16 is produced by drawing the thin-walled, flexible inner ring 17 while applying a compressive or tensile force on a first molded body 18. In the illustrated embodiment, the first molded body 18 has oval outer contours 19 on which the inner ring 17 is drawn. Then a second molded body 21 with similar oval outer contours 22 and a peg 23 are placed on the first molded body 18 and the inner ring 17 such that a hollow space 24 is produced in the interior of the inner ring 17.

Advantageously, the peg 23 projects into a recess 25 provided in the first molded body 18 when the molded bodies 18, 21 are brought together. The molded bodies 18, 21 have injection openings 26 for filling the hollow space 24 or for discharging the air contained in the hollow space during the injection molding or casting process. When the molded bodies 18, 21 are removed after the casting, the base body 16 is complete. If ribs 27 are placed in the hollow space 24 before the filling, then these act as reinforcement for the base body 16.

In FIG. 6, an alternative form of the outer contours 19 is shown. This is formed on the flat sides of the oval with straight sections 28. In this embodiment, the formation of injection edges is prevented for the case of deviations subject to tolerances between the molded bodies 18, 21 and the inner ring 17. Embodiments of the outer contours 19 in which only two pegs define the larger inner diameter of the oval are also conceivable. Likewise, for the use of inner contours, it can also be varied such that the inner ring contacts on the outside at least on the flat sides of the oval.

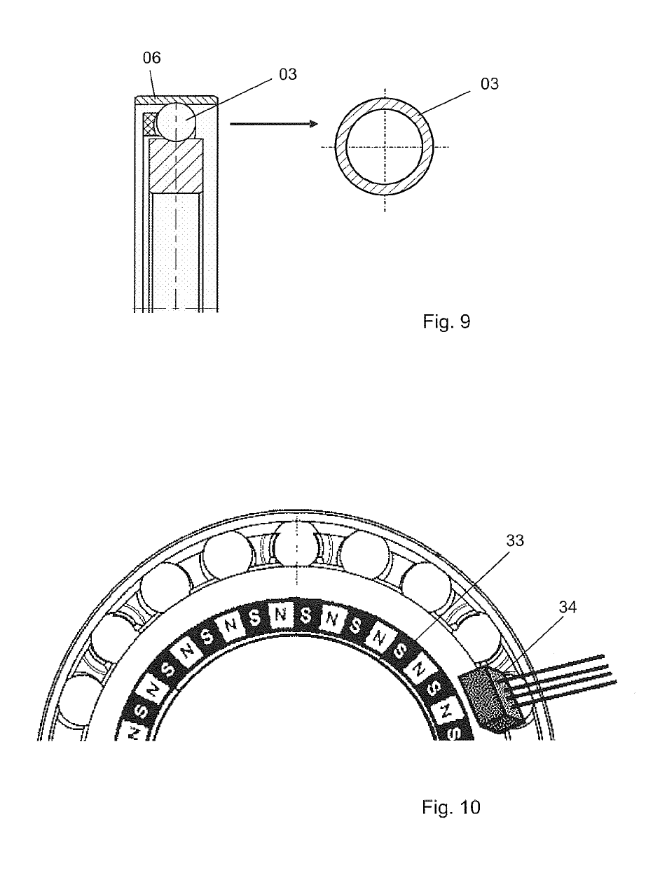

In another embodiment shown in FIG. 9, all or one part of the roller bodies 03 should be formed as a hollow body (hollow ball or sleeve instead of roller). The roller bodies 03 rotate as a function of the relative speed between the elliptical inner ring and outer ring 06 of the shaft generator as a set of balls about the central rotational axis and also due to the rolling about their own axis. Thus they form an essential part in the overall moment of inertia of the shaft generator. Through the formation as a hollow body, the load can also be reduced in the event of an end stop collision.

FIG. 10 shows an example for angle coding integrated into the inner ring as a schematic diagram. A magnetic ring 33 is integrated into the inner ring. For production, this was placed before being molded into the molded body. A sensor 34 connected rigidly to the housing detects the magnetic field of the rotating inner ring and transmits, for example, square sensor signals to a control unit (not shown) of the actuator, wherein the angular position of the inner ring can be determined from these signals in a known way.

### LIST OF REFERENCE NUMBERS

01 Adjustment shaft
02 Inner ring running surface
03 Ball
04 Cage
05 —
06 Outer ring
07 Projection
08 Receptacle hole
09 —
10 —
11 Adjustment shaft
12 Double-row ball bearing
13 Inner ring running surface
14 Inner ring running surface
15 —
16 Base body
17 Inner ring, flexible
18 Molded body, first
19 External contours
20 —
21 Molded body, second
22 External contours
23 Peg
24 Hollow space
25 —
26 Injection-molding opening
27 Rib
28 Straight section
29 Receptacle peg
30 Magnetic ring
31 External teeth
32 Recess
33 Magnet ring
34 Sensor

1. Triple-shaft adjustment mechanism, comprising a drive part that is connected to a drive shaft in a rotationally fixed manner, a driven part that is connected to a driven shaft, and an actuator that is connected to an adjustment shaft, a first mechanical stop is arranged between two of the three shafts for defining an adjustment angle between the drive shaft and the driven shaft, the mechanism part that is not part of the stop has a mass distribution or shape resulting in a quotient of less than 0.4 kg×mm calculated from a mass moment of inertia J and a reference circle radius r thereof.

2. Triple-shaft adjustment mechanism according to claim 1, wherein the stop is provided between the drive part and the driven part and the mechanism part that is not part of the stop is the actuator that is formed by a shaft generator of the shaft mechanism.

3. Triple-shaft adjustment mechanism according to claim 1, wherein the actuator is formed at least partially from plastic or lightweight metal.

4. Triple-shaft adjustment mechanism according to claim 3, wherein a base body of the shaft generator is made from plastic or lightweight metal.

5. Triple-shaft adjustment mechanism according to claim 2, wherein an adjustment shaft and an elliptical inner ring of the shaft generator are formed integrally.

6. Triple-shaft adjustment mechanism according to claim 5, wherein the adjustment shaft of the shaft generator has a cross-sectional face profile that differs from a rectangular cross section.

7. Method for producing a shaft generator of a triple-shaft adjustment mechanism according to claim 2, comprising the following steps:
a. drawing a flexible inner ring onto a first molded body while exerting a radial compressive or tensile force, in order to bring the inner ring into an oval shape;
b. forming a second molded body on the first molded body while forming a hollow space in an interior of the inner ring;
c. filling the hollow space between the molded bodies and the inner flexible ring with liquid plastic or lightweight metal; and
d. removing the inner ring from the mold.

8. Method according to claim 7, wherein the molding is carried out via an injection-molding.

9. Method according to claim 7, wherein reinforcing fibers are added to the plastic or lightweight metal.

10. Method according to claim 7, wherein the hollow space is provided with ribs before being filled.
